(19) United States
(12) Patent Application Publication
(10) Pub. No.: US 2019/0376315 A1
(43) Pub. Date: Dec. 12, 2019

(54) LOCK FOR A CLOSURE ELEMENT OF A REAL ESTATE PROPERTY, AND CORRESPONDING CLOSURE ELEMENT

(71) Applicant: ROTO FRANK AG, Leinfelden-Echterdingen (DE)

(72) Inventors: Peter STAPF, Leinfelden-Echterdingen (DE); Niklas GUTSCHE, Ulm (DE)

(73) Assignee: ROTO FRANK AG, Leinfelden-Echterdingen (DE)

(21) Appl. No.: 16/341,519

(22) PCT Filed: Oct. 17, 2017
(86) PCT No.: PCT/EP2017/076470

§ 371 Date: Apr. 12, 2019

(30) Foreign Application Priority Data
Oct. 19, 2016 (DE) 10 2016 012 609.4

(51) Int. Cl. E05B 17/00; E05B 47/02; E05B 63/00; E05B 63/14; E05B 47/06

(52) U.S. Cl. CPC E05B 17/0029; E05B 47/023; E05B 2047/0017; E05B 63/14; E05B 47/0607; E05B 63/0052

(57) ABSTRACT

A lock for a closure element of a real estate property, includes a pivoting catch on which a spring acts in a preferred direction, a locking member, and a manual or mechanical drive device. The locking member is designed as a rotary locking member that is driven by the drive device in a circulating manner about a locking member axis in only one rotational direction and comprises multiple locking elements which are offset to one another over the angle at the circumference of the locking member and which interact with the pivoting catch as respective tumblers depending on the rotational angle. Only one of the locking elements constantly acts directly on the pivoting catch for a locking and unlocking process, and the adjacent locking element opposite the rotational direction of the rotary locking member acts on the pivoting catch by rotating the rotary locking member for a subsequent locking and unlocking process.

The invention relates to a lock for a closure element, in particular for a door, of a property, comprising a pivoting catch, on which a spring acts in a preferred direction, a locking member, and a manual or mechanical drive device.

A lock of the type mentioned is known. It is installed in a closure element, in particular a door, of a property and allows a locking of the closure element. A locking member of the lock is mechanically driven by means of an electric motor and serves to establish or release the pivoting catch. When locking the pawl is brought motor in locking position. In this case, a corresponding counter-element, for example a strike plate, is engaged behind, whereby the closure element is locked. The locking member brought by means of the drive means in a corresponding position prevents the pivoting catch from leaving its locking position. If an unlocking has to be done, the locking member is displaced into a release position, which allows a displacement of the pivoting catch in the open position.

The known locks are sluggish, maintenance-prone and severely limited in terms of their lifetime. Furthermore, there is a high need for maintenance due to high wear of the moving components.

The object of the invention is therefore to provide a lock for the closure element of the property that works quickly, thus has short reaction times, has a long life and has low wear and low maintenance. This object is achieved in a lock of the type mentioned above in that the locking member is designed as a rotary locking member that is driven by the drive device in a circulating manner about a locking member axis in only one rotational direction and comprises multiple locking elements which are offset to one another over the angle at the circumference of the locking member and which interact with the pivoting catch as respective tumblers depending on the rotational angle, wherein only one of the locking elements constantly acts directly on the pivoting catch for a locking and unlocking process, and the adjacent locking element opposite the rotational direction of the rotary locking member acts on the pivoting catch by rotating the rotary locking member for a subsequent locking and unlocking process. For the locking and unlocking, the direct action on the pivoting catch occurs by the corresponding locking element of the locking member, wherein in the locking position, the corresponding locking member directly acts onto the pivoting catch, i.e. abuts against the pivoting catch, such that leaving the locking position is prevented. The locking element itself forms a guard locking. In the unlocking position, the locking member is displaced in such a way that there is no longer any action on the pivoting catch and the latter is therefore displaceable in the release position or is displaced into the release position. The aforementioned displacement of the corresponding locking element occurs in that the drive means rotates the locking member about the locking member axis by a corresponding angle of rotation, wherein there is only one direction of rotation of the locking member, that is, the drive means drives the locking member thus formed as a rotary locking member only in one direction of rotation. Since several locking elements arranged over the circumference of the rotary locking member angularly are present, several locking and unlocking operations can be performed per revolution of the locking member, whereby the lock has short reaction times and low wear and low maintenance and a long operating life. The movement taking place in only one direction of rotation of the rotary locking member also contributes to the longevity and low wear, wherein preferably not only the locking member has a single direction of rotation, but also the corresponding components of the drive device, in particular comprising a drive motor, particularly preferably comprising an electric motor, and in particular having a transmission.

The drive device is preferably a mechanical drive device. In principle, however, it is also conceivable that the drive device is operated manually. Since several locking elements are successively used in successive locking and unlocking processes during only one revolution of the rotary locking member, not only are the already mentioned short reaction times available, but the rotational speed of the rotary locking member can be kept very small despite short reaction times, with the result that a long life is provided. It is further provided that the drive means has force-displacement ratios which are optimally correlated with each other, whereby very high torques can be transmitted to the pivoting catch, ensuring a secure locking and unlocking of the lock even in case of occlusions and/or when the closure element is drawn to a corresponding counter element by the pivoting motion of the pivoting catch, in particular of a leaf element against its frame.

Due to the direct interaction of the respective active locking element of the rotary locking member with the pivoting catch, a simple and substantially backlash-free construction is realized. In addition, the manufacturing costs are thereby minimized.

According to a development of the invention, it is provided that the pivoting catch is locked in a closed position only by means of the respective locking element. Other components that hold the pivoting catch in the locked position, therefore, are not necessary. As a result, the number of components is low and the construction simplified, with a corresponding reduction in manufacturing costs.

It is advantageous if the locking elements are uniformly arranged with a mutual angular offset over the circumference of the rotary locking member. This leads to a uniform stress and thus to a longevity of the component.

For a low wear and a fast lock function, it has been found that the rotary locking member preferably has from two to five locking elements, in particular preferably three locking elements, which are angularly offset by 120° to each other. If two locking elements are provided, then two locking and unlocking operations can be performed for each revolution of the rotary locking member. For example, in case of five locking elements, five locking and unlocking operations per revolution of the rotary locking member are realized accordingly. Particularly advantageous is the case of three locking elements of the rotary locking member, which are particularly preferably angularly offset to each other, in a particularly uniform way, namely by 120°.

In a further development of the invention, it is provided that the rotary locking member has a gear which is rotatably mounted about the locking member axis. In particular, it is provided that the gear has an upper and lower side, and that the locking elements are arranged on the upper side. The formation of the rotary locking member with the gear has the advantage that the rotary locking member can be easily rotated in that the drive means comprises a drive gear meshing with the gear of the rotary locking member. Since the locking elements are located on the upper side of the gear, despite the space required for the drive of the rotary locking member, an interaction of the locking elements with the pivoting catch within the smallest space available is nevertheless possible, whereby the dimensions of the lock are minimized.

In particular, it is provided that the locking elements are formed asymmetrically such that at the same speed of rotation of the rotary locking member, the unlock time is smaller than the lock time, wherein in particular: unlock time=0.5 to 0.1×lock time. Due to the asymmetry of the respective locking element-without having different rotational speeds of the rotary locking member between locking and unlocking—the design is such that the unlocking requires a much shorter time than the locking. The locking time is calculated in view of the cooperation of the corresponding locking element with the pivoting catch such that the mentioned tensile forces are applied to apply the sealing pressure and so on. The unlock time is in contrast much smaller. It is equal to one half to about one tenth of the lock time, depending on how the asymmetry is provided, so that unlocking takes place almost instantaneously from the locking position.

It is preferably provided that the locking elements are designed as projections extending in the direction of the locking member axis, in particular in the form of round bolts which are flattened peripherally. The projections thus protrude to the outside from the upper side of the gear. Due to their preferably round bolt-like design, a steady interaction with the pivoting catch is provided, wherein the rounded shape, resulting from the round bolt-like design, provides a ramp-like interaction with the pivoting catch.

According to a development of the invention, it is provided that the locking elements are interconnected by means of radially extending spoke webs, in particular integrally connected ones. Since the spoke webs connect the locking elements together, a high rigidity of the component is achieved. Since the spoke webs extend radially, i.e. lead to the pivot point of the rotary locking member, a very good force transmission into the locking member axis, in particular into the locking member shaft, is also possible, so that very high tumbling forces can be absorbed. In particular, the tumbling forces are transmitted torque-free or substantially torque-free to the locking member axis, in particular to the locking member shaft. The locking member shaft may be connected to the rotary locking member, in particular integrally connected, but is preferably locally and optionally rotationally fixed in a housing of the lock, wherein the rotary locking member has a corresponding bearing opening into which the locking member shaft engages.

According to a development of the invention it is provided that the spoke webs are centrally connected to a hub, in particular integrally connected thereto, wherein the locking member axis centrally extends through the hub. The hub is a machine element, which is pushed onto the locking member axis or the locking member shaft.

A development of the invention consists in that the gear, the locking elements, the spoke webs and the hub are integrally formed with each other.

The pivoting catch has an upper side, a lower side and a circumferential front side.

It is preferably provided that between each two adjacent locking elements a free space is positioned extending over a peripheral region of the rotary locking member, for a cam of the pivoting catch to pass through, when the pivoting catch is rotated into the unlocking position. If the pivoting catch is in the locking position and the lock is now unlocked, then it is necessary for the corresponding locking element of the rotary locking member to release the cam of the pivoting catch so that the pivoting catch can rotate out of its locking position into its unlocked position. In this case, the cam moves in a corresponding manner, which requires a corresponding space, in order for the pivoting catch to reach its unlocking position. Thus, for example, the cam must not hit against an adjacent locking element in order to reach the unlocking position.

A further development of the invention provides that the cam extends over only a portion of the thickness of the pivoting catch and that the portion of the thickness remaining in the region of the cam is designed as a free area for partially receiving the gear of the rotary locking member. The free area ensures that the two components, namely the pivoting catch and the rotary locking member, can be very closely adjacent to each other, without causing any hindrance. However, the gear may have a correspondingly large diameter in order to develop optimal torques.

According to a development of the invention, it is provided that the pivoting catch has a receiving recess for a locking element, in particular for a locking pin, preferably a mushroom locking pin. The receiving recess receives, in the locking case, the locking element safely in that the receiving recess completely surrounds the locking element, so that the closure element, in particular the door, is locked securely. A closure element having the locking element is thereby fixed immovably. The arrangement is preferably made such that the lock is in/on a frame and that the locking element is arranged in/on a wing element, in particular a door leaf of a door of the property. However, the reverse arrangement is also conceivable.

According to a development of the invention, it is provided that the receiving recess is open to the front face of the pivoting catch and preferably extends at least partially at an acute angle to the radial direction with respect to a pivotal bearing of the pivoting catch. As a result, the receiving recess does not extend along the radial direction passing through the pivot bearing but at an acute angle to the radial direction, which need not be a fixed acute angle, but may vary over the course of the receiving recess, in particular it is provided that the receiving recess-viewed from the bottom of the pivoting catch—is arcuate, in particular slightly arcuate. In this way, in relation to the locking operation with respect to the associated interaction with the locking element, a control is achieved, which is designed in particular such that a good force-displacement relationship is correlated with a firm and secure closing of the closure element, in particular also with increasing closure forces, for example by compressing a seal and/or by deformation of the closure element, for example, in a warped door leaf or the like.

It is preferably provided that the height of the receiving recess extends over the entire thickness of the pivoting catch or includes only a portion of the thickness of the pivoting catch. The receiving recess crosses the thickness of the pivoting catch completely or partially, wherein in the latter case, a material area remains, whereby the mechanical strength of the pivoting catch is increased.

A development of the invention provides that the lock has a lock housing. This has already been mentioned above. Furthermore, the lock housing has a lower wall, a ceiling wall and two longitudinal walls and two front walls, wherein for allowing the introduction of the locking element, the lock housing has an inlet slot which penetrates one of the longitudinal walls and the lower wall or passes through one of the longitudinal walls, the lower wall and the ceiling wall. Thus, the inlet slot is a “corner slot”, i.e., it passes through the longitudinal wall and then continues in the lower wall and/or the ceiling wall. Preferably, the inlet slot is rectilinear. In particular, it may be provided that the region of the inlet slot in the longitudinal wall has a greater width than in the lower wall or ceiling wall, wherein the slot area in the lower wall or ceiling wall is preferably designed such that it tapers there, funnel-like-starting from the longitudinal wall-, to a minimum slot width, which then remains constant. Due to the fact that the receiving recess and the inlet slot intersect—at least partially-, a secure holding of the locking element is ensured.

According to a development of the invention, it is provided that the pivoting catch has at least one abutment step/surface which interacts with at least one counter/mating surface of the lock housing to limit the unlocking position of the pivoting catch.

It is preferably provided that for a particularly contactless signal transmission, the rotary locking member and/or the pivoting catch has at least one/have each at least one sensor element interacting with at least one sensor member of a control device located in the lock housing for detecting the position of the rotary locking member and/or the position of the pivoting catch. This provides the control device, which is designed in particular as an electronic control device, with accurate position information about the position of the rotary locking member and/or the pivoting catch. The control device can therefore optimally control the mechanical drive, in particular the electric motor.

A further development of the invention provides that the cam has a control curve sliding along the respective locking element, in particular for running along the locking element during a locking process. This cam is particularly designed so that at the beginning of the locking process a relatively long distance is traveled, and a correspondingly lower force is exerted on the locking element, and that in the course of the locking process the distance traveled decreases while force is increased, up to theoretically infinite force, in particular in a dead center of the control curve.

In particular, it is provided that—as already mentioned—the drive means comprises an electric motor, which is coupled via the transmission also mentioned above with the gear of the rotary locking member. According to a preferred embodiment, the transmission has at least one worm and a plurality of gears. It is also conceivable, however, to provide the transmission as a planetary, spur or worm gear. It is also conceivable that the drive device is a direct drive and/or has a rack and/or has a belt drive.

A development of the invention provides that the at least one sensor element is designed as a permanent magnet.

Furthermore, it is preferably provided that the sensor member has a Hall sensor.

In particular, a sensor element is located in each/at each locking element, so that each individual locking element can be monitored by the control device with respect to its position.

A further development of the invention provides a pre-locking device which pre-locks the pivoting catch to prevent the extraction of the locking element from the receiving recess in a pre-locking position. If the locking element is inserted into the receiving recess, this leads due to the deviation from the radial direction of the receiving recess to a rotational displacement of the rotary locking member (at least one of the walls of the receiving recess is acted upon by the locking element), with the result that the pivoting catch is pivoted into the pre-locking position and that the locking element cannot leave the receiving recess in this pre-locking position. This pre-locking position is therefore locked by means of the pre-locking device, so that an extraction of the locking element is prevented. For example, the closure element can be pushed closed by a person without it reopening by itself, for example by wind pressure and/or sealing pressure and/or spring pressure of the pivoting catch.

A particular holding action of the locking element in the receiving recess in the pre-locking position is additionally obtained by the fact that the receiving recess extends at an angle to the radial direction of the pivoting catch, preferably arcuately, and that the inlet slot has a straight course, creating a “crossing” of receiving recess and pivoting catch in the pre-locking position, and the locking element is located in the crossing area.

A further development of the invention provides that the pre-locking device has a displaceable locking part which, in the pre-locking position, acts in a locking manner on the pivoting catch, in particular by preventing it from opening. If the pre-locking position is reached by the pivoting catch, the locking part is displaced and prevents the pivoting catch from pivoting back into the unlocking position.

In particular, it is provided that the locking part is biased by means of a spring device and is released in the case of pre-locking to bring about the pre-locking position. In the case of release, the spring device displaces the locking part in the locking position.

In particular, it is provided that the release of the locking member occurs by retraction of the locking element in the receiving recess, in particular by pivoting caused by the retraction of the pivoting catch. Preferably, when the locking element is retracted into the receiving recess, the pivoting catch is pivoted into the pre-locking position, this pivoting movement being used to release the locking part.

In particular, it is provided that in a unlocking process, a displacement of the locking member into a release position takes place by a corresponding rotational position of the rotary locking member. As a result, the locking part does not hinder the return of the pivoting catch into its unlocking position.

Subsequently, by further rotation of the rotary locking member, the biased locking member is released again for a renewed cycle.

Finally, the invention relates to a closure element, in particular a door, of a property, which is provided with a lock, as described above in the various embodiments.

The drawings illustrate the invention with reference to an embodiment, in which:

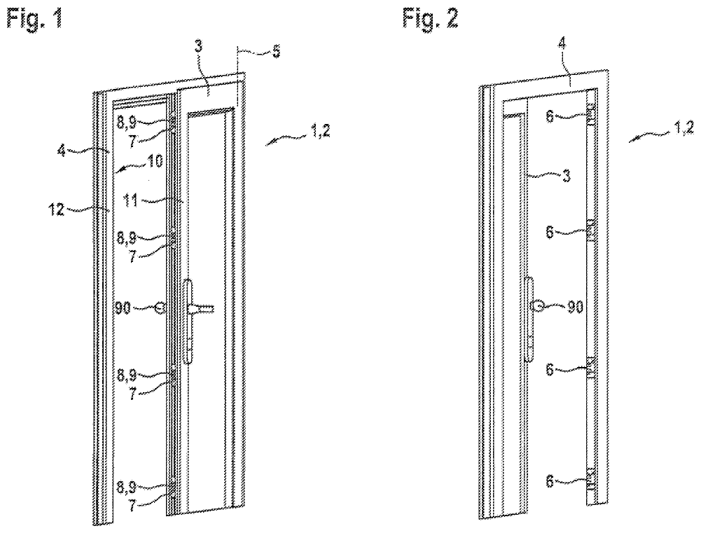

FIG. 1 shows a perspective inside view of a closure element of a property, wherein the closure element, which is designed as a door, has a lock,

FIG. 2 is a view corresponding to FIG. 1, but from the outside, i.e. an external view of the closure element,

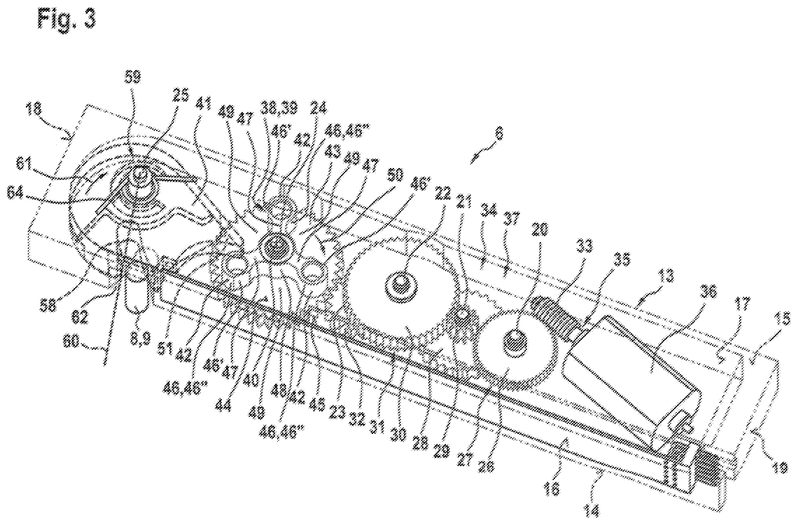

FIG. 3 is a perspective view of the lock,

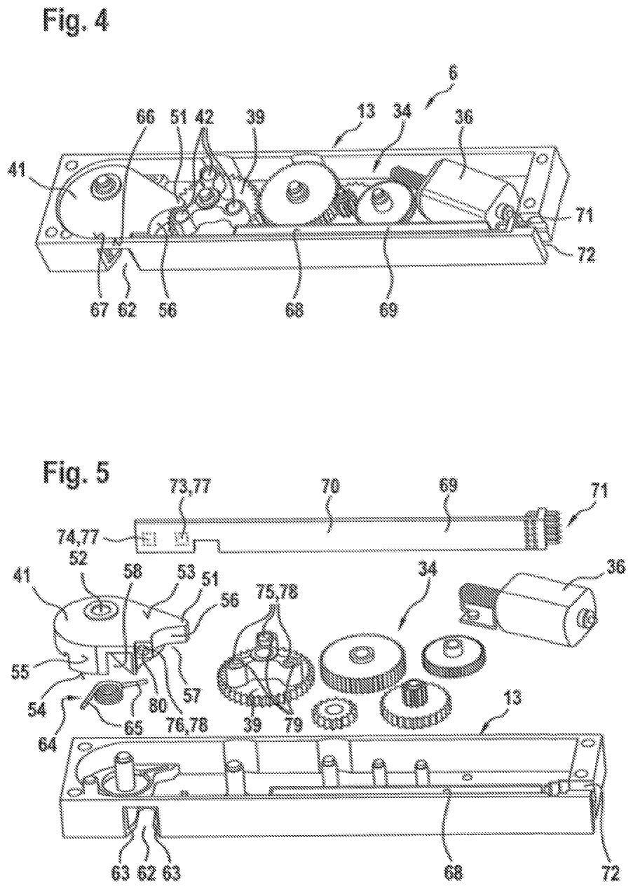

FIGS. 4 and 5 show perspective views of the lock in the assembled state and in an exploded view,

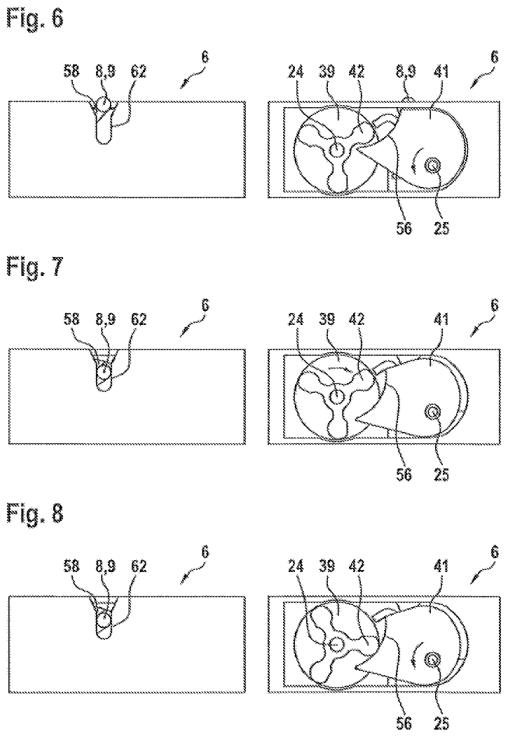

FIGS. 6 to 13 are schematic views of the lock in different operating states,

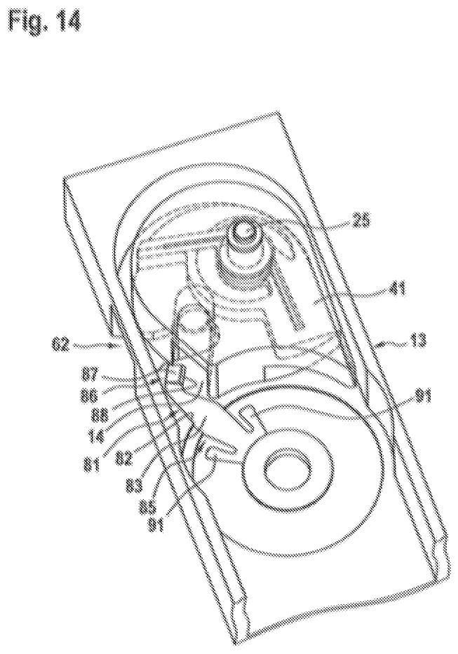

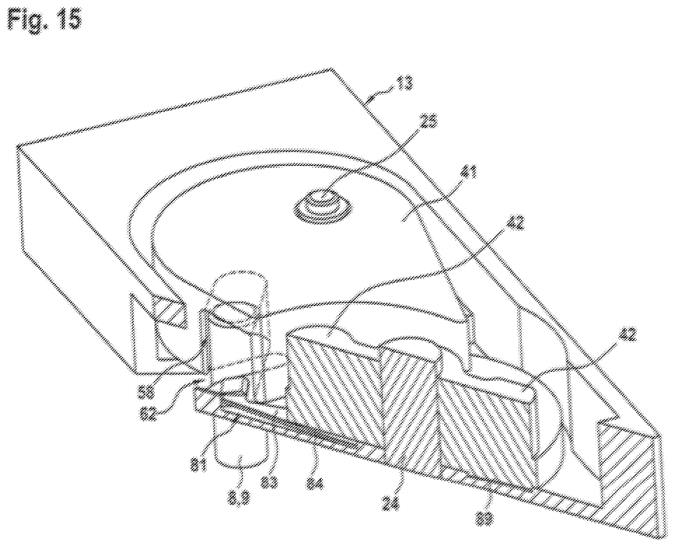

FIG. 14 shows a detailed view of the lock,

FIG. 15 is a further detailed view of the lock,

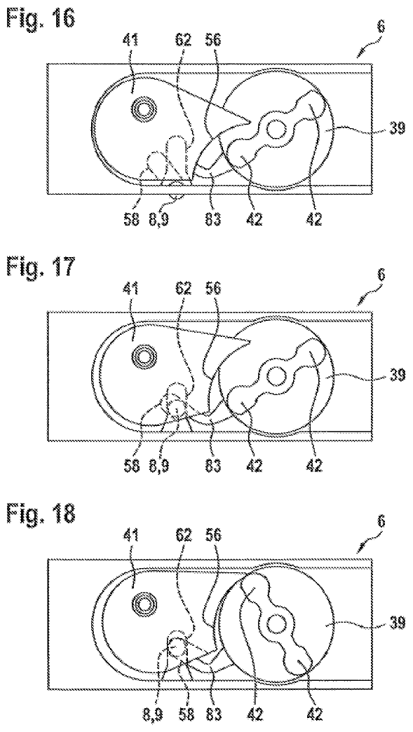

FIGS. 16 to 18 are schematic views of the lock in different operating states, corresponding to a pre-locking,

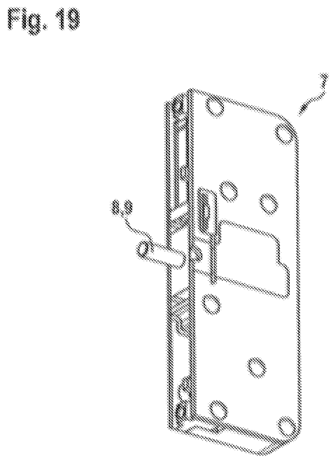

FIG. 19 shows a perspective view of a closure element, which cooperates with the lock and has a locking pin as locking element,

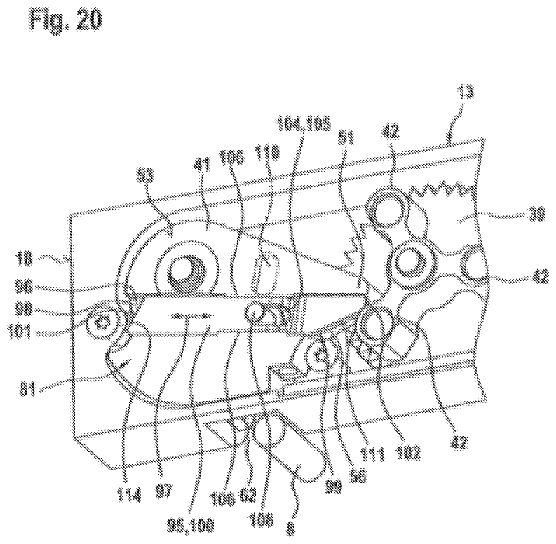

FIG. 20 shows a perspective view of a region of the lock with a further embodiment of the pre-locking,

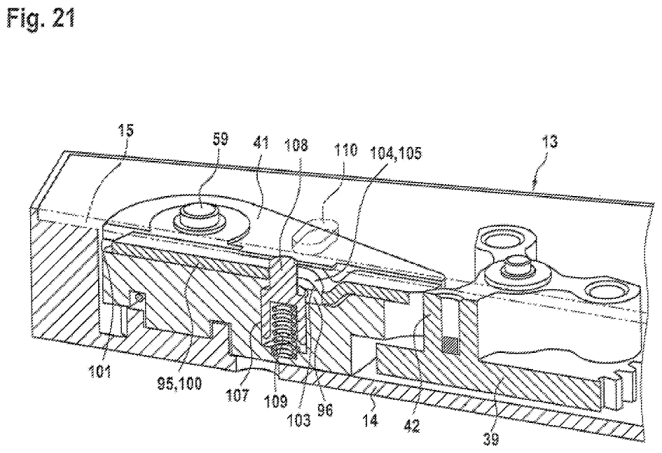

FIG. 21 shows the embodiment of FIG. 20 in a perspective cross-section and

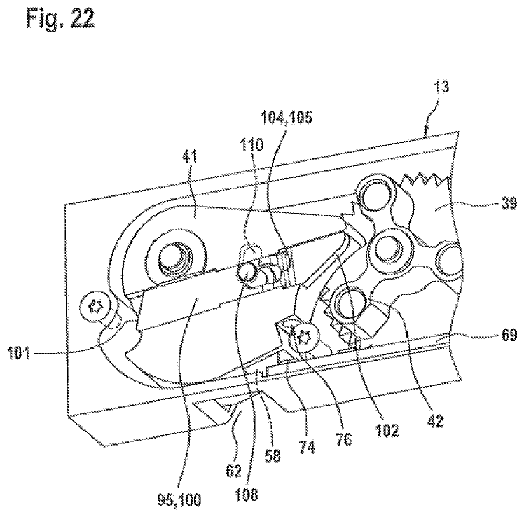

FIGS. 22 to 26 show different operating states corresponding to the illustration in FIG. 20.

FIG. 1 shows a closure element 2 of a property designed as a door 1. The door 1 is, for example, a front door. The door 1 has a wing element 3, which is mounted in a frame 4 rotatably about a vertical axis 5. The door 1 is shown partially open in FIGS. 1 and 2, wherein FIG. 1 shows an inside view and FIG. 2 shows an outside view. The inside view is a view of the door 1 from the inside of the property and the outside view is a view of the door from outside the property.

According to FIG. 2, the frame 4 is equipped with a plurality of locks 6. FIG. 1 shows that each of the locks 6 can interact with a closure element 7, wherein the closure elements 7 are located on the wing element 3. Each closure element 7 has a locking element 8, which is preferably designed as a locking pin 9. The locks 6 and the closure elements 7 are located in a rebate air zone 10 of the closure element 2, and preferably on those vertical beams 11 and 12 of the wing element 3 and the frame 4, which lie opposite the vertical axis 5. In the embodiment of FIGS. 1 and 2, a total of four locks 6 and four locking elements 7 are provided in said area; of course, more or fewer locks 6 and closure elements 7 may be provided and also more beams of wing element 3 and frame 4 may be provided with locks 6 and closure elements 7, such as horizontally extending elements and/or in the region of the threshold of the door. It is also possible to additionally provide the hinge side of the door, that is to say the side which has the vertical axis 5, with at least one lock 6 and at least one closure element 7. If a horizontally extending element and/or the threshold of the door are provided with at least one lock 6 and one closure element 7, then, in the locked state, the closure element 2—for example, in a break—in attempt-cannot be moved laterally, whereby security is increased. For the sake of simplicity, only one lock 6 and one closure element 7 will be described in the following-unless otherwise specified. If more locks 6 and closure elements 7 are provided, they are designed accordingly. Since a plurality of spaced-apart locks 6 and closure elements 7 can be used, in particular over at least a part of the circumference of the closure element 2, the closure element 2 can be locked absolutely securely, wherein through a corresponding pressure, even irregularly closing wing elements 3, such as due to deformation, may be locked and pulled together with at least a partial removal of warp. Possible leaks are eliminated.

FIG. 3 illustrates the construction of the lock 6. It has a lock housing 13, which has a lower wall 14, a ceiling wall 15, two longitudinal walls 16 and 17 and two front walls 18 and 19. The ceiling wall 15 is shown transparent in FIG. 3 in order to be able to look into the interior of the lock housing 13. On the lower wall 14 a plurality of studs 20 to 25 are attached and/or formed integrally with the lower wall 14. On the stud bolts 20 to 25—as shown in FIG. 3—components of the lock 6 are rotatably or pivotally mounted. Gears 26, 27, 28, 29, 30, 31 and 32 are provided, which form a transmission 34 together with a worm 33. The gears 26 and 27 are a double gear, the gears 28 and 29 are a double gear and the gears 30 and 31 are also formed as a double gear, that is, there are two gears axially fixed to each other, in particular integrally connected. The worm 33 is arranged non-rotatably on a drive shaft 35 of an electric motor 36 located in the interior of the lock housing 13. The worm 33 meshes with the gear 26. The gear 27 meshes with the gear 28. The gear 29 meshes with the gear 30; the gear 31 meshes with the gear 32. In the manner described above, there is a strong reduction, starting from the drive shaft 35 of the electric motor 36 to the gear 32. As in gears 28 and 29, also gears 26 and 27 and 30 and 31 have strong differences in diameter in order to provide the largest possible reduction. However, the gears 27 and 31 are not visible in the FIG. 3, since they are covered by the gears 26 and 30. The electric motor 36, together with the transmission 34, forms a drive means 37, with which a locking member 38 is driven. The locking member 38 is formed as a rotary locking member 39. It is rotatably mounted about a locking member axis 40, wherein the locking member axis 40 is formed by the stud 24. The rotary locking member 39 is located in the interior of the lock housing 13. Further, a pivoting catch 41 is pivotally mounted in said lock housing 13. The bearing takes place by means of the stud bolt 25. The pivoting catch 41 is shown transparent to recognize details of the construction.

The rotary locking member 39 has a plurality of locking elements 42 which are angularly offset in relation to each other over its circumference. In the embodiment of FIG. 3, three locking elements 42 are provided which are each offset by 120° to each other. Further, the rotary locking member 39 has a gear 43 which has an upper side 44 and a lower side 45. The lower side 45 faces the lower wall 14. On the upper side 44, the locking elements 42 are fixed, in particular integrally formed with the gear 43. The locking elements 42 are formed as projections 46 extending in the direction of the locking member axis 40, wherein the projections 46 are in particular round bolt-like projections 46 with flat portions 46′. Thus, the projections 46 form flattened round bolts 46″. These are each formed as follows: Due to the circumferentially flattened round bolt 46″ there results an asymmetry in the interaction with the pivoting catch 41 such that the time for unlocking the lock 6 is shorter, in particular substantially shorter than the time for the locking operation. It may preferably be provided that the locking elements 42 are connected to one another by means of radially extending spoke webs 47, in particular in one piece. The spoke webs 47 are centrally connected to a hub 48, in particular integrally connected, wherein the locking member axis 40 extends centrally through the hub 48. In particular, it is provided that the gear 43, the locking elements 42, the spoke webs 47 and the hub 48 are integrally formed with each other.

According to FIG. 3, it can be seen that between each two adjacent locking elements 42 there is a clearance 49 extending over a circumferential region of the rotary locking member 39. Furthermore, it can be seen from FIG. 3 that the gear 32 meshes with the gear 43, that is to say that the electric motor 36 drives the rotary locking member 39 during operation via the transmission 34. The arrangement is designed such that a drive of the rotary locking member 39 takes place in only one direction of rotation, which is represented by an arrow 50. In the embodiment of FIG. 3, the rotation of the rotary locking member 39 is in the clockwise direction (in a view from above on the upper wall 15 of the lock housing 13). The electric motor 36 is thus operated in only one direction of rotation to drive the rotary locking member 39 in only one direction of rotation.

The pivoting catch 41 is disposed in the interior of the lock housing 13 and pivotally mounted about the stud bolt 25. According to FIGS. 3 to 5, the pivoting catch 41 has a cam 51 which—as will be explained in more detail below-interacts with the rotary locking member 39, in particular with the locking elements 42 of the rotary locking member 39, depending on the operating state. The cam 51 is spaced from a bearing hole 52, in which the stud bolt 25 engages. Basically, the pivoting catch 41 has an upper side 53, a lower side 54 and a circumferential front side 55. The cam 51 has a control curve 56 in the region of the front side 55. As shown in FIG. 5, the cam 51 extends over only a portion of the thickness of the pivoting catch 41, wherein the portion of the thickness remaining in the region of the cam 51 is formed as an open area 57 for partially receiving the gear 43 of the rotary locking member 39.

In the region of the front side 55, the pivoting catch 41 has a receiving recess 58 for the locking element 8, in particular for the locking pin 9. Accordingly, the receiving recess 58 opens to the front face 55 of the pivoting catch 41 and extends, at least in certain areas, at an acute angle to the radial direction, as can be seen in particular FIG. 3, wherein the radial direction is a radial line, which passes through a pivot bearing 59, wherein the pivot bearing 59 is formed by the stud bolt 25 and the bearing hole 52. The radial direction is indicated by dashed line 60 in FIG. 1n particular, it is provided that the receiving recess 58 has no fixed acute angle to the radial direction, but has an arcuate, in particular a slightly arcuate profile, as can be seen clearly from FIG. 3.

The pivoting catch 41 is resiliently urged in a preferred direction. The preferred direction is shown in FIG. 3 by means of an arrow 61. As a result, the pivoting catch 41 is urged in its unlocking position. In this unlocking position, the entrance of the receiving recess 58 lying on the front face 55 is aligned with an inlet slot 62 of the lock housing 13. The inlet slot 62 passes through the longitudinal wall 16 and the lower wall 14 each for a distance. Preferably, the inlet slot 62 extends parallel to the front wall 18. In particular, it is provided that the inlet slot is funnel-shaped on the inlet side due to a corresponding oblique profile 63, whereby a catch funnel for the locking element 8 is formed, which ensures an automatic height compensation.

The height of the receiving recess 58 extends only over a region of the thickness of the pivoting catch 41, so that the upper side 53 of the pivoting catch 41 is designed to be closed and thereby has a high mechanical strength. For biasing the pivoting catch 41 in its preferred direction, a spring 64 (FIGS. 3 and 5) is provided, which surrounds the stud bolt 25 and has two front arms 65, wherein the one front arm 65 is supported on the pivoting catch 41 and the other front arm 65 is supported under preload on the lock housing 13. In order to limit the pivot angle of the pivoting catch 41, this has a abutment surface 66 which can cooperate with a mating surface 67 of the lock housing 13 (see FIG. 4).

In order to ensure a simple assembly of the spring 64, it is preferably provided that the spring 64 may be fixed on the pivoting catch 41 which has not yet been inserted into the lock housing 13 in particular by clamping. If the pivoting catch 41 is subsequently inserted into the lock housing 13, this is done in such a way that the corresponding front arm 65 of the spring 64 is introduced into a recess of the lock housing 13; the pivoting catch 41 is rotated to generate a bias of the spring 64 and simultaneously pressed into the front position.

In the interior of the lock housing 13 a control device 69 is housed-mostly in a separate compartment 68—which has a circuit board 70 with control electronics and electrical connections 71, wherein the latter are accessible from the outside through a incision 72 of the lock housing 13. The circuit board 70 is electrically connected to the electric motor 36 and has two sensor members 73 and 74 for a contactless signal transmission with respect to sensor elements 75 and 76 of the rotary locking member 39 and the pivoting catch 41. The sensor members 73 and 74 are each formed as Hall sensors 77 and the sensor elements 75 and 76 as permanent magnets 78. Each locking element 42 is assigned a sensor element 75. The sensor elements 75 are located in recesses 79, in particular blind holes, of the locking elements 42. The sensor element 76 is located in a depression 80 of the pivoting catch 41.

According to FIGS. 14 and 15, the lock 6 is provided with a pre-locking device 81, which-without the machine drive device 37, in particular the electric motor 36, being put into operation, prevents an extension of the locking member 8 from the receiving recess 58 after retraction. This is done by the pivoting catch 41 being pivoted by the retraction of the locking element 8 in a pre-locking position and the pre-locking device 81 being prevented from leaving this pre-locking position (for a re-extension of the locking element 8). Rather, first a complete locking process—as will be described in more detail below—is to be performed.

The pre-locking device 81 has in a recess 82 of the lower wall 14 of the lock housing 13 a displaceable locking member 83 which is biased by a spring means 84 which is designed like a leaf spring, such that it tends to move out of the recess 82 in an upward direction. The arrangement is such that an end portion 85 of the locking member 83 can be acted upon from the lower side 45 of the gear 43, thus the rotary locking member 39, as is apparent in particular from FIG. 15 (right bottom side of the rotary locking member 39). The other end portion 86 of the locking member 83 has a run-up step 87 with locking edge 88. At the lower side 45 of the gear 43 slot guides 89 having run-up ramps are located-distributed over the circumference of the rotary locking member 39, according to the number of locking elements 42. In the embodiment of FIG. 15, two locking elements 42 are provided so that a corresponding number of slot guides 89 is present.

If the rotary locking member 39 has, for example, three locking elements 42, as can be seen from FIG. 3, then three slot guides 89 are accordingly provided. The slot guides 89 effect-depending on the rotational position of the rotary locking member 39-a compression or releasing of the locking member 83, such that the run-up step 87 is immersed in the recess 82 or protrudes from this (the latter, if not depressed by the pivoting catch 41). If the run-up step 87 protrudes from the recess 82, then the locking edge 88 can prevent the pivoting catch 41 from turning back into the inlet slot 62 and the receiving recess 58 after retraction of the locking element 8 and thus releasing the locking element 8 again. The contour of the locking member 83 and thus also of the recess 82 is very wide, preferably designed with side arms 91 to prevent tilting of the locking member 83 in the recess 82 at a retraction and extension of the run-up step 87.

Hereinafter, the operation of the lock 6 is explained specifically for a locking and unlocking operation and subsequently for bringing about a pre-locking position by means of the pre-locking device 81. It should be noted that the pre-locking device 81 is an option of the lock 6, so it may be present, but does not necessarily have to be present.

It is assumed that the closure element 2 is in a position as shown in FIGS. 1 and 2, that is, the wing element 3 is in an open state. Now, if the door 1, is closed, for example, by a person who wants to leave the property, due to the person gripping an outside knob 90 (FIGS. 1 and 2) and the wing member 3 pivots on the frame 4 about the vertical axis 5, then the situation according to FIG. 6 with respect to the lock 6 is obtained. Below only one of the locks 6 will be discussed, while corresponding situations occur in the other locks 6 of the door 1. FIGS. 6 to 13 each schematically show on the left side the position of the locking element 8, preferably designed as a locking pin 9, in the inlet slot 62 of the lock 6. On the right side, FIGS. 6 to 13 show the corresponding position of the rotary locking member 39 and the pivoting catch 41 respectively on the left side.

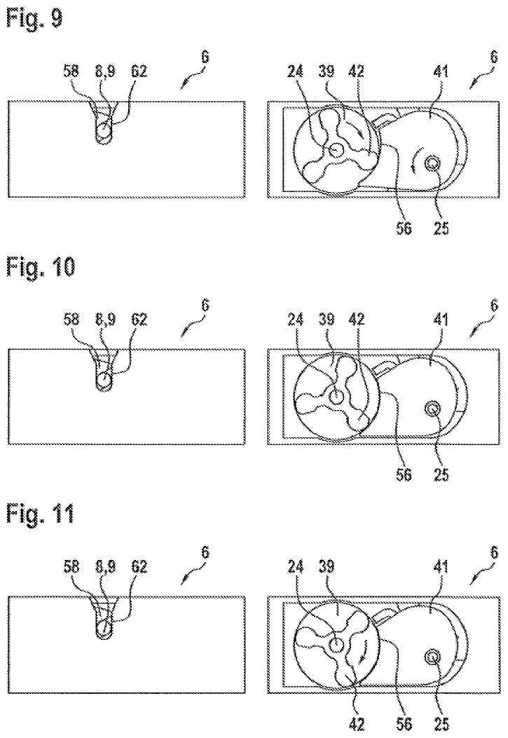

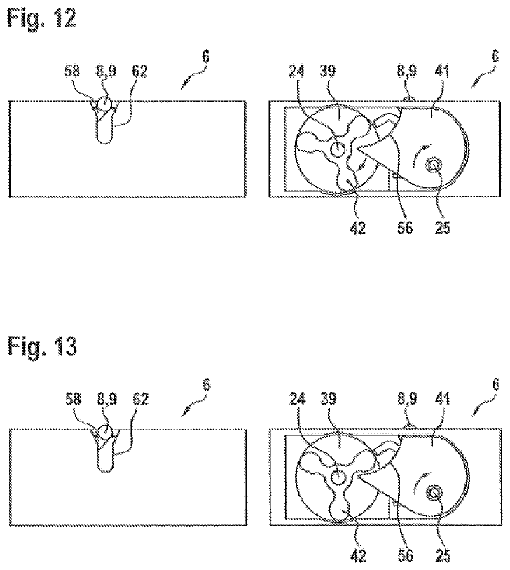

According to FIG. 6 when closing the door 1, the locking element 8 at least partially enters the inlet slot 62 and the receiving recess 58 and thereby acts on a side wall of the receiving recess 58 with the result that upon further entry according to FIG. 7, the pivoting catch 41 pivots a bit. The mentioned closing of the closure element is detected by means of a sensor, not shown, of the closure element and/or the displacement of the pivoting catch 41 by the control device 69, that is, the sensor member 74 of the circuit board 70 detects the present position of the sensor element 76 of the pivoting catch 41. As a result, the control device 69 starts the electric motor 36 which drives the rotary locking member 39 in the only one direction of rotation (clockwise in the exemplary embodiment) via the transmission 34, so that the situation according to FIG. 8 results. The relevant locking element 42 abuts against the control curve 56 and thereby rotates the pivoting catch 41 in the position according to FIG. 9. As a result, the locking element 9 is pulled further into this and also into the inlet slot 62 by the corresponding, in particular curved, course of the receiving recess 58, so that pre-tightening of the wing element 3 takes place, which is for example greater than 5 mm. In the further course of the locking operation, the rotary locking member 39 is rotated to the position shown in FIG. 10, wherein this position corresponds to the locking position. In this position, the electric motor 36 turns off. Switching off occurs by means of the aforementioned control device 69 by sensing the position of the pivoting catch 41 and/or the position of the rotary locking member 39, wherein this position is detected due to the interaction of the sensor member 73 and/or 74 on the circuit board 70 and the sensor element 75 and/or 76. The design of the control curve 56 is such that there is an optimal force-displacement ratio, which initially involves a long travel distance with little force and later a shorter travel with a lot of force up to virtually infinite force according to a transition from FIG. 9 to FIG. 10. In FIG. 10, the locking element 42 acts as a tumbler for the pivoting catch 41. In the locking operation, the rotary locking member 39 preferably has a uniform speed, and the rotational speed of the pivoting catch 41 is decreased due to the eccentricity. This benefits the closing force curve, which is initially low and then rises sharply to the front position, that is, the generated contact pressure increases sharply. This has the consequence that the wing member 3 is strongly pressed against an existing seal on the frame 4. In the position shown in FIG. 10, the contact pressure forces are derived torque-free by the present dead center position in the pivot bearing 59. If an unlocking operation is now to be carried out, then the operator reactivates, for example by key operation (also by code entry on an input field), fingerprint sensor actuation or similar, the drive device 37, that is, the electric motor 36 continues to rotate in its previously direction of rotation, thus in the same direction, so that a disengage of the locking element 42 from the pivoting catch 41 according to FIG. 11 occurs. This is done by very short travels and therefore almost in real time (less than 0.5 s), that is, there are no waiting times. The control device 69 senses the corresponding situation by the previously mentioned sensor components, which results in that the rotary locking member 9 is rotated further, namely according to FIG. 12 to the position shown in FIG. 13, wherein this position corresponds again to that of FIG. 6. By releasing the pivoting catch 41 it pivots back, supported by the spring 64, whereby a release of the locking element 8 takes place and the door 1 can be opened.

The already mentioned pre-locking operation will now be explained with reference to FIGS. 16 to 18 in conjunction with FIGS. 14 and 15. If the locking element 8 according to FIG. 16 initially runs into the receiving recess 58 and the inlet slot 62, then the locking part 83 is in a position not acted on by the rotary locking member 39, i.e. is free, but is pressed down by the pivoting catch 41, i.e. is in the recess 82. If the locking element 8 continues to move in accordance with FIG. 17, then the pivoting catch 41 pivots into a position in which the locking part 83 is no longer acted upon, that is to say it is urged upwards by the spring device 84, so that the locking edge 88 of the run-up step 87 in accordance with FIG. 15 protrudes out of the recess 82 and the locking edge 88 prevents a reverse rotation of the pivoting catch 41. It can be seen on the basis of the so to speak crossing directions of receiving recess 58 and inlet slot 62 according to FIG. 17, that in the situation shown in FIG. 17, the locking element 8 can no longer escape from the lock, so that there is a pre-locking. This pre-locking is particularly important if, for example due to a power failure, an operation of the lock 6 with the electric motor 36 is no longer possible. Nevertheless, by simply pressing the door 1, a locking state, namely the aforementioned pre-locking state, may be effected in a purely mechanical way. The latter is particularly important when slamming the door 1, in order to “catch” it.

FIG. 18 illustrates the transition from the pre-locking position into the locking position. The electric motor 36 rotates the rotary locking member 39 in the tumbler position. In this case, a slot guide 89, which is located at the bottom of the rotary locking member 39, presses the locking member 83 down into the recess 82. If the unlocking state is now to be established, unimpeded opening is possible on account of this downward pressing of the locking part 83, that is to say the pivoting catch can pivot back into the position according to FIG. 16. Afterwards the pre-locking is active again.

The above-explained in case of a locking or a pre-locking take place per revolution of the rotary locking member 39 due to the multiple locking elements 42, according to their number.

FIGS. 20 to 26 show a further exemplary embodiment of a pre-locking device 81. With regard to the other embodiment of the lock 6, reference is made to the statements and the figures of this patent application in order to avoid repetition. The pre-locking device 81 of FIGS. 20 to 26 has a control member 95 which is slidably mounted on the pivoting catch 41. For this displaceable mounting, the pivoting catch 41 has a bearing groove 96, which lies in particular on the upper side 53. In the bearing groove 96, the control member 95 is slidably mounted in the direction of the double arrow 97 resulting from FIG. 20. The bearing groove 96 extends over the entire plan dimension of the pivoting catch 41 and is open at both ends. The one end 98 of the bearing groove 96 is opposite the front wall 18 of the lock housing 13 and the other end 99 of the bearing groove 96 extends into the cam 51 and to the control curve 56. The control member 95 is designed in particular as a control tongue 100, wherein one end 101 of the control member 95 may interact with the front wall 18 and the other end 102 of the control member 95 may interact with the respective relevant locking element 42.

According to FIG. 21, the control member 95 has a section 103 of its lower side bent in the direction of the lower wall 14. The control member 95 has a through hole 104, which is formed as a slot 105. The slot 105 extends in the direction of the longitudinal extent of the control tongue 100. In order to prevent the control member 95 from escaping upwards from the bearing groove 96, it is provided in particular that retaining tabs 106 located on the upper side 53 of the pivoting catch 41 hold the control member 95 in the bearing groove 96, but do not hinder the longitudinal displacement according to the double arrow 97. These retaining tabs 106 can be created, for example, in that, in particular when the control member 95 is inserted into the bearing groove 96, the material of the pivoting catch 41 is compressed in order to form the retaining tabs 106. In the pivoting catch 41 there is a blind hole-like bearing recess 107 which receives a locking pin 108 which is biased in the direction of the upper wall 15 by means of a spring 109. The spring 109 is located within the bearing recess 107. The ceiling wall 15 has a slot-like locking recess 110 which passes through the ceiling wall 15 partially or completely and can cooperate with the locking pin 108. The slot-like locking recess 110 preferably has a shape such that it lies around the pivot bearing 59 on a partial circle section.

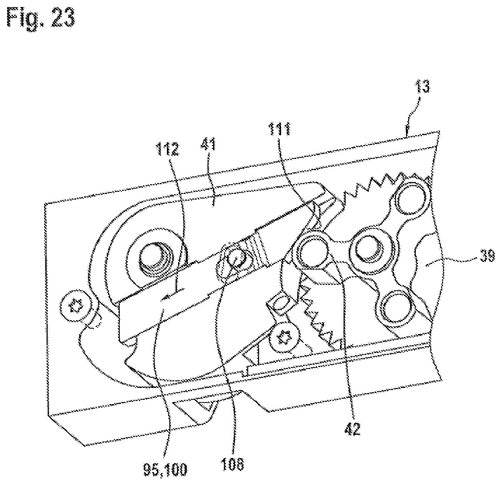

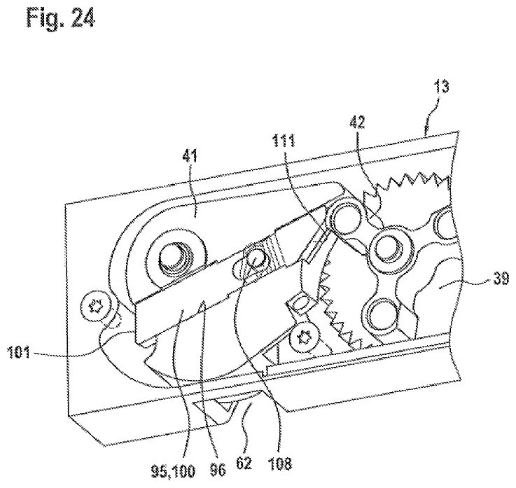

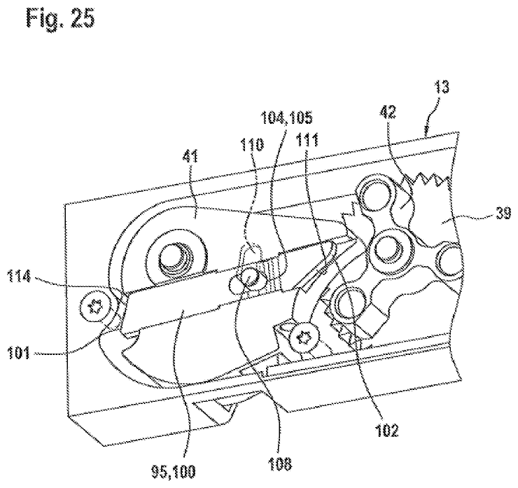

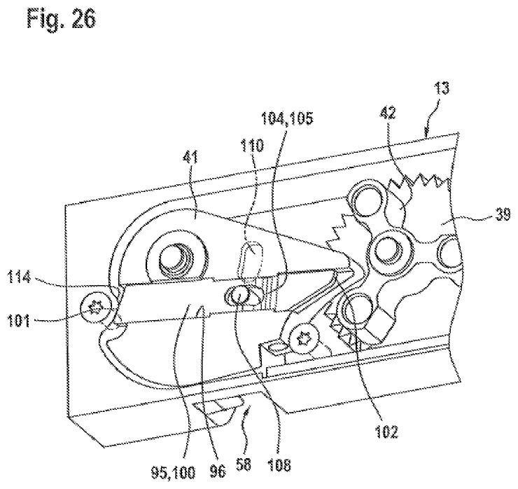

According to FIGS. 20 and 22 to 26, the following function results for the pre-locking device 81: According to FIG. 20, the locking element 8 has not yet entered the receiving recess 58 or the inlet slot 62. In the other FIGS. 22 to 26, the locking element 8 is not shown. If the wing element 3 is now moved into the closed position, the locking element 8 entering the receiving recess 58 causes a rotational displacement of the pivoting catch 41, as has already been described in the previous exemplary embodiment of the pre-locking device 81. The result is the position according to FIG. 22. In this position, the locking pin 108—driven by the spring 109—has entered the locking recess 110, so that the pivoting catch 41 cannot pivot back and therefore the locking element 8 cannot escape from the receiving recess 58. The pre-locking position is now present. The displacement of the pivoting catch 41 into the position according to FIG. 22 is recognized by the control device 69 based on the interaction of sensor element 74 and sensor element 76, with the result that the rotation locking element 39 is set in rotation, as shown in FIGS. 23 and 24. In this case, the active locking element 42 strikes against a chamfer 111 formed at the end 102 of the control member 95 and urges it in the direction of the arrow 112 as shown in FIGS. 23 and 24, whereby the arcuate portion 103 of the control member 95 depresses the locking pin 108, so that it no longer penetrates into the locking recess 110. If the position according to FIG. 24 is left for an unlocking operation, that is, the rotary locking member 39 rotates into the position according to FIG. 25, the pivoting catch 41 can pivot backwards due to the depressed locking pin 108 until the position according to FIG. 20 is reached again. In this process, the control member 95 initially does not move in the bearing groove 96, because it has a slight inhibition against displacement in the bearing groove 96 and/or the locking pin 108 exerts a transverse force on the control member 95. Returning the control member 95 from the position according to FIG. 26 into the position according to FIG. 20 takes place only at the end of the pivoting-back movement of the pivoting catch 41 in that the end 101 of the control member 95 is acted upon by the front wall 18. In particular, the front wall 18 has a control contour 114 for the displacement of the control member 95.

Due to the invention, the following peculiarities arise: The mechanically moving parts of the drive device 37 move only in a single direction of rotation, whereby a long-lived, low-wear and preferably maintenance-free operation is possible. Since the rotary locking member 39 has a plurality of locking elements 42 distributed over its circumference, a full revolution leads to several locking and unlocking operations. This results in short reaction times with low wear. Furthermore, the service life of the motor is increased during operation of the lock. Instead of the electric motor 36, of course, another type of motor or a manual drive can be used. Due to the design with cams 51 and control curve 56 and the corresponding formation of the locking elements 42 favorable leverage and travel relationships and also a responsive operation may be achieved. Thus, the unlocking can be done in less than 0.5 s. The transmission of motion to the rotary locking member 39 is effected by gear connection, which brings favorable conditions with it. The respective position of the rotary locking member 39 and/or the pivoting catch 41 can preferably be realized without contact due to the mentioned elements, in particular Hall sensors 77. Alternatively, however, Reed contacts can also be used. The resulting asynchronicity due to the design of locking and unlock time leads to a low wear and practical advantageous operation.

FIG. 19 illustrates the closure element 7. This has, as a locking element 8, the locking pin 9. The locking element 8, in particular the locking pin 9, may be rigid, which means that it is not axially displaceable. Alternatively, an embodiment is possible in which the locking element 8, in particular the locking pin 9, is axially retractable, whereby unlocking of the closure element 2 is made possible.

According to FIGS. 1 and 2, the locks 6 are located in the frame 4 and the closure elements 7 in the wing element 3. In such a case, no passage of an electric cable from the frame 4 to the movable wing member 3 is required because the electrically powered locks 6 are in the frame 4. Alternatively, it is also possible for the locks 6 to be located in the wing element 3 and the closure elements 7 in the frame 4. The mentioned cable passage to the wing element 3 is required in the arrangement of the locks 6 in the wing element 3 in order to supply energy to the electric motors 36 of the locks 6.

1. A lock for a closure element of a property, the lock comprising:
a pivoting catch on which a spring acts in a preferred direction;
a locking member; and
a manual or mechanical drive device;
wherein the locking member is a rotary locking member driven by the drive device in a circulating manner about a locking member axis in only one rotational direction and comprises a plurality locking elements offset to one another over an angle at a circumference of the locking member and which interact with the pivoting catch as respective tumblers depending on a rotational angle, and
wherein only one locking element of the plurality of locking elements constantly acts directly on the pivoting catch for a locking and unlocking process, and an adjacent locking element opposite the rotational direction of the rotary locking member acts on the pivoting catch by rotating the rotary locking member for a subsequent locking and unlocking process.

2. The lock according to claim 1, wherein the pivoting catch is closed only by means of the respective locking element.

3. The lock according to claim 1, wherein the locking elements are uniformly arranged with an angular offset over the circumference of the rotary locking member.

4. The lock according to claim 1, wherein the rotary locking member has from two to five locking elements, preferably three locking elements, which are mutually angularly offset by 120°.

5. The lock according claim 1, wherein the rotary locking member has a gear which is rotatably mounted about the locking member axis.

6. The lock according to claim 5, wherein the gear has an upper and a lower side, and that the locking elements are arranged on the upper side.

7. The lock according to claim 1, wherein the locking elements are formed asymmetrically such that, at the same speed of rotation of the rotary locking member, unlock time<lock time, in particular: unlock time=0.5 to 0.1×lock time.

8. The lock according to claim 1, wherein the locking elements are formed by projections extending in the direction of the locking member axis, in particular peripherally flattened round bolts.

9. The lock according to claim 1, wherein the locking elements are connected, in particular integrally, to each other by means of radially extending spoke webs.

10. The lock according to claim 9, wherein the spoke webs are centrally connected, in particular integrally connected to a hub, wherein the locking member axis extends centrally through the hub.

11. The lock according to claim 9, wherein the rotary locking member has a gear which is rotatably mounted about the locking member axis, and wherein the gear, the locking elements, the spoke webs and the hub are integrally formed with each other.

12. The lock according to claim 1, wherein the pivoting catch has an upper side, a lower side and a peripheral front face.

13. The lock according to claim 1, wherein between each two adjacent locking elements a clearance is provided over a peripheral region of the rotary locking member, which clearance is provided for passing through of a cam of the pivoting catch when the pivoting catch is rotated into an unlocking position.

14. The lock according to claim 1, wherein the rotary locking member has a gear which is rotatably mounted about the locking member axis, and wherein the cam extends over only a portion of a thickness of the pivoting catch and that a part of the thickness remaining in a region of the cam is formed as a free region for partially receiving the gear of the rotary locking member.

15. The lock according to claim 1, wherein the pivoting catch has a receiving recess for a locking element, in particular for a locking pin.

16. The lock according to claim 15, wherein the receiving recess opens towards a front face of the pivoting catch and preferably at least partially forms an acute angle with a radial direction with respect to a pivot bearing of the pivoting catch.

17. The lock according to claim 16, wherein the receiving recess viewed from the lower side of the pivoting catch is arcuate, in particular slightly arcuate.

18. The lock according to claim 15, wherein a height of the receiving recess extends over an entire thickness of the pivoting catch or comprises only a portion of the thickness of the pivoting catch.

19. The lock according to claim 1, wherein the lock has a lock housing having a lower wall, a ceiling wall and two longitudinal walls and two front walls and in that, for an insertion of the locking element, the lock housing has an inlet slot passing through one of the longitudinal walls and the lower wall or passing through one of the longitudinal walls, the lower wall and the ceiling wall.

20. The lock according to claim 1, wherein the pivoting catch has at least one abutment step/abutment surface which interacts with at least one counter-step/mating surface of the lock housing for limiting an unlocking position of the pivoting catch.

21. The lock according to claim 1, wherein for a preferably contactless signal transmission, the rotary locking member and/or the pivoting catch have at least one or each have at least one sensor element, which interacts with at least one sensor member of a control means arranged in the lock housing for detecting a position of the rotary locking member and/or the position of the pivoting catch.

22. The lock according to claim 1, wherein the cam has a control curve for a running along of the respective locking element, in particular for a sliding of the locking element occurring during a locking process.

23. The lock according to claim 5, wherein the drive device has an electric motor which is coupled via a transmission with the gear of the rotary locking member.

24. The lock according to claim 21, wherein the at least one sensor element is designed as a permanent magnet.

25. The lock according to claim 21, wherein the at least one sensor member has a Hall sensor.

26. The lock according to claim 1, wherein a sensor element is located in/on each locking element.

27. The lock according to claim 15, wherein a pre-locking device which pre-locks the pivoting catch in a pre-locking position to prevent the locking element from moving out of the receiving recess.

28. The lock according to claim 27, wherein the pre-locking device has a displaceable locking part which in a pre-locking position acts on the pivoting catch in a locking manner, in particular by preventing it from opening.

29. The lock according to claim 28, wherein the locking part is biased by means of a spring device and is triggered in case of a pre-locking, to bring about the pre-locking position.

30. The lock according to claim 29, wherein the release of the locking member occurs by retraction of the locking element into the receiving recess, in particular by pivoting of the pivoting catch caused by the retraction.

31. The lock according to claim 28, wherein during an unlocking operation, a displacement of the locking part into a release position occurs due to a corresponding rotational position of the rotary locking member.

32. The lock according to claim 1 in combination with a closure element.
